(19) United States
(12) Patent Application Publication
(10) Pub. No.: US 2012/0183487 A1
(43) Pub. Date: Jul. 19, 2012

(54) Novel Composition for Treating External Injuries and Eschars

(76) Inventors: Henri Graugnard, Le Paradou (FR); Laura Poli, Marin (FR); Dominique Dissard, Entrance (FR); Denis Gilotin, Moins (FR); Jean-Charles Jay, Monsteroux Milieu (FR)

(21) Appl. No.: 13/496,757

(22) PCT Filed: Sep. 15, 2010
(86) PCT No.: PCT/FR2010/051916

§ 371 Date: Mar. 16, 2012

(30) Foreign Application Priority Data
Sep. 17, 2009 (FR) 09 56395

(51) Int. Cl. A01N 1/00

(52) U.S. Cl. 424/75

(57) ABSTRACT

The present invention relates to the use of a composition comprising 2-bromo-2-nitropropane-1,3-diol for external treatment of tissues of corpses.

The present invention relates to a novel composition intended for treating external injuries and eschars, and more particularly within the scope of thanatopractice care.

There exist compositions intended for the aforementioned treatment comprising formaldehyde. However, formaldehyde is a toxic and corrosive compound, and its handling is therefore dangerous for the operators. Therefore, development of compositions free of formaldehyde is required.

Many treatments of internal parts of the body during thanatopractice care exist to this day. For example, the Applicant has already described in French Patent Application no. 08/51637 filed on Mar. 13, 2008, a solution intended for injection into arteries or cavities.

However, with treatments of interior body tissues, it is not possible to effectively protect potentially affected and damaged areas which are sometimes located on the outer areas of the body. Indeed, the treatment carried out by irrigation of the bloodstream or through cavities, for areas which are external to the body, cannot be sufficiently effective for checking degradation of the thereby affected tissues and having high risks of rapid degradation.

Now, the relevant areas are generally those which have been subject to violent trauma generated by bodily injuries or simply resulting from an autopsy or from degradations/openings of tissues (eschars) resulting from repeated pressures exerted by certain parts of the body on surrounding objects. This is notably the case of bedsores resulting from the laid-down position on a hospital bed, for example, on which the repeated pressures of certain parts of the body (back, elbows, ankles) may lead to the occurrence of open eschars which are highly infectious necrotic areas which may be deep and are difficult to treat. In these scenarios, degradation and putrefaction of these tissues are observed, either existing before the death of the deceased (case of eschars) and/or rapid degradation of the wounds which are accompanied by strong and persisting smells which are extremely detrimental within the scope of presentation of the deceased to the family and close relatives.

It therefore seems to be necessary in order to check degradation of these areas and to suppress the smells, to proceed with a treatment which consists of covering/smearing the relevant areas with a sterilizing substance and covering them with watertight bandages.

To the knowledge of the inventors, there does not exist any composition adapted to the treatment of external injuries and of eschars, which is effective and not very dangerous to the environment and to the operators.

The object of the present invention is therefore to provide a sterilizing composition which rapidly stops degradation and putrefaction of the tissues for a sufficient time (of the order of a fortnight).

Another object of the present invention consists of providing a composition which may be easily spread and which adheres to the body and to the skin.

Finally, the object of the present invention is also to provide a colored composition so that considering its biocidal aspect, it may be totally localized in order to be able to proceed with making bandages covering the whole surface of the relevant areas.

Thus, the present invention relates to the use of a composition comprising 2-bromo-2-nitropropane-1,3-diol for the external treatment of tissues of corpses, notably for the treatment of eschars and of external injuries present on such tissues.

More particularly, the present invention relates to the use of a composition comprising 2-bromo-2-nitropropane-1,3-diol and at least one gelling agent for external treatment of tissues of corpses, notably for treating eschars and external injuries present on such tissues.

In particular, the composition according to the invention may be used for performing thanatopractice care or for preserving anatomic parts of corpses, in particular human corpses. The anatomic parts correspond to pieces of corpses, for example a limb, a hand. The composition may notably be used for preserving bodies intended to be dissected.

Bronopol or 2-bromo-2-nitropropane-1,3-diol (C₃H₆BrNO₄) is a crystalline powder, the color of which varies from white to pale yellow.

This product is stable and is used as a bactericide.

Bronopol is a biocide which has no or few risks for human health and for operators and persons in contact with the deceased. By using it, inhalation of vapors by the practitioner may be avoided upon carrying out care operations. Moreover, bronopol does not have any volatility at room temperature.

The term of “thanatopractice” refers to care aimed at preservation and presentation of the body of a deceased, i.e. embalming techniques or which relate to the embalming of corpses.

Bronopol is used here for its antiseptic and sterilizing properties.

Indeed, for these external applications in essence, the use of bronopol results from its ascertained antiseptic and sterilizing properties in the other solutions (arteries and cavities) as well as from its non-volatile aspect at room temperature avoiding any breathing contact with possible vapors containing biocidal products firstly for the care operators and more generally for persons (family, relatives . . . ) which may stand in proximity to the deceased.

Preferably, the aforementioned composition comprises at least 2% by weight, typically 2% to 10% by weight, notably from 3% to 6% by weight of bronopol based on the total weight of the composition.

Preferably, it comprises of the order of 4% by weight (for example between 3.5 and 4.5% by weight) of bronopol based on the total weight of the composition.

The composition used within the scope of the present invention comprises a low bronopol content, which is particularly advantageous from the point of view of the environmental aspect. However this content is sufficient for obtaining sufficient antiseptic and sterilizing activity.

According to a particularly advantageous embodiment, the aforementioned composition is applied on the tissues, and more particularly on the eschars and external injuries, of a corpse, notably of a human corpse.

According to a preferred embodiment, the aforementioned composition further comprises a diluent. This diluent provides said composition with malleability, moistening and body-adhesion properties.

Among diluents, mention may notably be made of ethanol and methanol, methanol being more preferred.

The diluent is preferably present in an amount from 4 to 20% by weight, preferably from 4% to 10% by weight based on the total weight of the composition.

According to a particularly advantageous embodiment, said composition comprises methanol as a diluent in an amount of 6% by weight based on the total weight of the composition. This amount is particularly advantageous as regards the viscosity, malleability and adhesion obtained for said composition. Indeed the amount should be selected so that the obtained composition has an “unctuous” aspect. Now, a too large amount of diluent is not advantageous since the obtained composition would be too liquid.

The amount of diluent is preferably less than 10% by weight based on the total weight of the composition insofar that the increase in the diluent percentage leads to gradual decrease in the viscosity, this being detrimental to the adhesion characteristics of the composition on the treated wounds.

According to a preferred embodiment, the aforementioned composition further comprises a gelling agent. This gelling agent gives the composition a slurry aspect, which is exactly sought for the contemplated applications. The thereby obtained composition is therefore in the form of a balm.

Among the gelling agents, mention may notably be made of sodium alginate.

The gelling agent is preferably present in an amount from 5% to 15% by weight based on the total weight of the composition.

According to a particularly advantageous embodiment, said composition comprises sodium alginate as a gelling agent in an amount of 10% by weight based on the total weight of the composition. This amount is particularly advantageous as regards consistency and malleability of said composition. Indeed, the amount should be selected so that the obtained composition has an “unctuous” aspect. Now, a too large amount of gelling agent causes hardening of the composition. The viscosity is then high, which causes poor malleability as well as low adherence to the tissues.

Generally, the aforementioned preferred amounts of gelling agent and of diluent allow the composition to be easily spreadable and its consistency to be such that the contact with the tissues is entire and that a composition layer spread over the tissues is sufficiently thick to hinder the passage of oxygen and therefore to suppress putrefaction phenomena and the passing of gases and smells.

According to a preferred embodiment, the aforementioned composition further comprises a coloring agent.

The coloring agent gives the composition a strong coloration by which the areas covered with said composition may be properly distinguished, in order to avoid any contact with these areas and to be able to completely cover them with watertight bandages.

Among the coloring agents, mention may be made of any agent coloring tissues. Among the coloring agents used, mention may be made in addition to amaranth (which gives a reddish pink coloration) and eosin (which gives a pink coloration), poppy red (which gives a cherry red coloration), erythrosine (which gives a cherry red coloration) and carminic acid (which gives a carmine red coloration).

These coloring agents are inert, i.e. they are only used for pigmenting the composition of the invention and these products are classified per color range depending on the encountered subjects.

According to a more preferred embodiment, the composition used within the scope of the present invention comprises eosin as a coloring agent. Thus, preferably the coloring agent used in the balm according to the present invention is the same coloring agent as the one used in the arterial solution with however a little stronger concentration so as to give the balm a more sustained color so that it may easily be totally located during the care operations.

The present invention therefore relates to the use of a balm for treating eschars and external injuries within the scope of thanatopractice care, said balm comprising water, bronopol, a diluent such as methanol, a gelling agent such as sodium alginate, and a coloring agent such as eosin.

The present invention also relates to a composition comprising 2-bromo-2-nitropropane-1,3-diol, for external treatment of tissues of corpses, in particular for treating eschars and external injuries, said composition preferably comprising at least 2% by weight, typically from 2% to 10% by weight, notably from 3% to 6% by weight of 2-bromo-2-nitropropane-1,3-diol based on the total weight of the composition.

Preferably, this composition is intended to be applied on eschars and external injuries of corpses, notably during performing thanatopractice care.

The present invention also relates to a composition comprising 2-bromo-2-nitropropane-1,3-diol and at least one gelling agent, for external treatment of tissues of corpses.

The present invention also relates to the aforementioned compositions as such. Thus, the present invention also relates to a composition comprising 2-bromo-2-nitropropane-1,3-diol, a diluent and a gelling agent, said composition being characterized in that it comprises from 2% to 10% by weight, notably from 3% to 6% by weight of 2-bromo-2-nitropropane-1,3-diol based on the total weight of the composition.

The aforementioned composition may also contain a coloring agent.

The present invention also relates to a composition comprising 2-bromo-2-nitropropane-1,3-diol, a diluent and sodium alginate as a gelling agent, said composition being characterized in that it comprises from 2% to 10% by weight, notably from 3% to 6% by weight of 2-bromo-2-nitropropane-1,3-diol based on the total weight of the composition.

The aforementioned composition preferably comprises from 4% to 20% by weight, preferably from 4 to 10% by weight of diluent, notably methanol or ethanol, based on the total weight of the composition.

It also comprises preferably from 5% to 15% by weight of gelling agent, notably sodium alginate, based on the total weight of the composition.

According to an advantageous embodiment, the composition according to the invention is in the form of a balm and is intended to be applied on external injuries and eschars.

It is more particularly intended to be applied on external injuries and eschars of human corpses, upon performing thanatopractice care operations.

According to a more preferred embodiment, the composition according to the invention comprises for 1,000 grams:

| | |
|---|---|
| bronopol: | 40 g |
| methanol or ethanol (diluent): | 60 g |
| sodium alginate (gelling agent): | 100 g |
| water: | balance |
| eosin (coloring agent): | a few drops for coloration |
| | (typically 10 drops) |

Within the scope of Ia present invention, the compositions used preferably do not comprise any surfactant, and more particularly they do not comprise any quaternary ammonium compound. Preferably, the compositions according to the invention do not comprise any gallic acid or polyvinyl alcohol.

### EXPERIMENTAL PART

A balm was prepared from the following composition (1,000 g):

| | |
|---|---|
| bronopol: | 40 g |
| methanol: | 60 g |
| sodium alginate: | 100 g |
| eosin: | 10 drops |
| water: | balance |

Following the use of this balm which is spread very easily and with a lot of adherence on the infected (or which may rapidly become infected) external parts, an immediate halt to degradation and putrefaction of the tissues was noticed, accompanied by disappearance of the smells present.

After performing the care operations and following covering of the wounds, no persisting odor of any nature was observed.

The thereby treated and then dressed body did no longer show any sign suggesting the presence of existing concealed eschars and injuries.

1-13. (canceled)

14. A method for external treatment of tissues of corpses comprising the application of a composition on external injuries and eschars, said composition comprising 2-bromo-2-nitropropane-1,3-diol and at least one gelling agent.

15. The method according to claim 14, wherein the composition comprises from 2% to 10% by weight of 2-bromo-2-nitropropane-1,3-diol based on the total weight of the composition.

16. The method according to claim 15, wherein the composition comprises from 3% to 6% by weight of 2-bromo-2-nitropropane-1,3-diol based on the total weight of the composition.

17. The method according to claim 14, wherein the gelling agent is present in a comprised amount from 5% to 15% by weight based on the total weight of the composition.

18. The method according to claim 17, wherein the gelling agent is present in an amount of 10% by weight based on the total weight of the composition.

19. The method according to claim 14, wherein the gelling agent is sodium alginate.

20. The method according to claim 14, wherein the composition comprises a diluent.

21. The method according to claim 20, wherein the diluent is selected from ethanol or methanol.

22. The method according to claim 20, wherein the diluent is present in a comprised amount from 4% to 20% by weight based on the total weight of the composition.

23. The method according to claim 22, wherein the diluent is present in a amount of 6% by weight based on the total weight of the composition.

24. The method according to claim 14, wherein the composition comprises a coloring agent.

25. The method according to claim 24, wherein the coloring agent is eosin.

26. A composition comprising 2-bromo-2-nitropropane-1,3-diol and at least one gelling agent, for external treatment of tissues of corpses.

27. The composition according to claim 26, comprising from 2% to 10% by weight of 2-bromo-2-nitropropane-1,3-diol based on the total weight of the composition.

28. A composition comprising 2-bromo-2-nitropropane-1,3-diol, a diluent, a gelling agent, wherein said composition comprises from 2% to 10% by weight of 2-bromo-2-nitropropane-1,3-diol based on the total weight of the composition.

29. The composition according to claim 28, wherein the gelling agent is sodium alginate.

30. The composition according to claim 28, comprising from 4% to 20% by weight of diluent based on the total weight of the composition and from 5% to 15% by weight of gelling agent based on the total weight of the composition.

31. The composition according to claim 28, in the form of a balm intended to be applied on external injuries and eschars.
